(19) United States
(12) Patent Application Publication
(10) Pub. No.: US 2015/0252927 A1
(43) Pub. Date: Sep. 10, 2015

(54) Flange Connection

(71) Applicant: INFICON GMBH, Köln (DE)

(72) Inventor: Sebastian Weiß, Manlius, NY (US)

(21) Appl. No.: 14/435,902

(22) PCT Filed: Oct. 16, 2013
(86) PCT No.: PCT/EP2013/071596

§ 371 Date: Apr. 15, 2015

(30) Foreign Application Priority Data
Oct. 16, 2012 (DE) 20 2012 009 902.7

(51) Int. Cl. F16L 23/028; F16L 41/00; F16L 41/03

(52) U.S. Cl. CPC F16L 23/0283; F16L 41/03; F16L 41/007

(57) ABSTRACT

A flange for separably connecting a pipe to a connection block is designed as an interrupted ring with an inner and an outer edge and has a bottom side designed for mating against the connecting block and against the pipe and an upper side opposite the bottom side, designed to mate with fasteners for fastening the flange on the connection block. The flange is wherein an outer contact web projecting from the bottom side in the region of the outer edge is provided for the connection block and an inner contact web projecting from the bottom side in the region of the inner edge is provided for the pipe.

The invention relates to a flange for establishing a releasable connection of a pipe conduit to a connection block.

Flange connections are mostly used for connecting a pipe end to another pipe element or object. Flange connections attain particular importance in pump technology since, in this field, it is desired to establish stable and leak-tight connections between pipe conduits and pipe conduit connectors. A typical case is the connection of a pipe conduit to a connection block to which a fluid is to be supplied from the pipe conduit. The connection block, functioning as a nodal point or distribution site, can serve for supplying the fluid flows from one pipe conduit to other pipe conduits or vice versa.

Typically, a flange, formed as a ring element, has the function to enclose the end of the pipe conduit and to fasten this end to the connection block or to another underlying surface in a tight and sealing manner. It is known to use an interrupted ring element consisting of a plurality of parts, thus rendering it more convenient to place the ring element around the end of the pipe conduit. Said flange ring has a bottom side configured for abutment on the connection block or to another underlying surface, and a top side facing away from said bottom side. The top side is configured to receive fastening elements, such as e.g. screws and their heads, and to transmit the contact pressure of the screw heads via the bottom side of the flange ring onto the connection block or the underlying surface. In this regard, the bottom side of the flange ring has to contact, at least indirectly, the connection block and respectively the underlying surface as well as also the pipe conduit. The flange ring transmits the contact pressure onto a suitably formed end of the pipe conduit—e.g. a collar at the end of the pipe conduit—and thus presses the end of the pipe conduit onto the connection block and respectively the underlying surface.

In known flange connections, a difficulty resides in that transverse forces acting onto the pipe conduit parallel to the surface of the connection block and respectively of the underlying surface, will act as bending forces transversely to the longitudinal axis of the fastening elements and may happen to cause damage to—or breakage of—the fastening elements.

It is an object of the invention to provide an improved flange connection for a pipe conduit.

The flange according to the invention is defined by the features of claim 1.

In accordance therewith, the flange is provided with an outer contact web for the connection block, said outer contact web extending from the bottom side in the area of the outer edge, and with an inner contact web for the pipe conduit, said inner contact web extending from the bottom side in the area of the inner edge. In the attached state of the flange, the contact webs have a continuous annular shape, wherein the outer contact ring is supported on the connection block and the inner contact ring is at least indirectly supported on the pipe conduit, e.g. on a mounting collar at the end of the pipe conduit. The outer contact web is thus configured to transmit the contact pressure of the fastening element onto the connection block or the underlying surface to which the pipe conduit is fastened. The inner contact web is configured to transmit the contact pressure of the fastening means onto the end of the pipe conduit that is to be fastened, e.g. onto a projecting collar of the pipe conduit. In such an arrangement, the two contact webs can be formed independently from each other in accordance with the distance between the flange and the connection block and between the flange and the pipe conduit. Thereby, bending moments with the fastening means are reduced because the fastening means are subjected to a higher extent of tensile forces. As a result, the flange connection is of enhanced stability and reliability.

Preferably, the contact webs are each arranged orthogonally to the bottom side of the flange ring and respectively of the elements of the flange ring, thus allowing them to take up particularly high forces orthogonally to the bottom side and to the top side of the flange ring.

Preferably, each contact web has a constant height throughout its circular periphery, the height being adapted to the distance between the flange bottom side and the pipe end, and respectively between the flange bottom side and the connection block. In this arrangement, the heights of the inner contact web and of the outer contact web are different from each other. In this manner, the contact webs allow for a more uniform force transmission orthogonally to the bottom side of the flange.

The width of each contact web can decrease toward the projecting end of the web in order to reduce the contact area.

The inner edge and the outer edge can delimit the flange toward the inside and respectively the outside so that no portions of the flange extend beyond the inner and outer edges. Typically, the flange ring is formed of at least two equal-sized parts, each of the two parts being provided with an identical number of openings for the fastening means. Said openings extend fully through the flange from its bottom side to its top side. Typically, the fastening means are screws which will be inserted through the openings from the top side in the direction of the bottom side and, for attachment, will engage with corresponding threads formed in the connection block. In the resulting arrangement, the head of a screw is supported on the top side of the flange or within a recess in the top side.

An exemplary embodiment of the invention will be explained in greater detail hereunder with reference to the Figures. In the Figures, the following is shown:

FIG. 1 is a perspective exploded view of a flange connection,

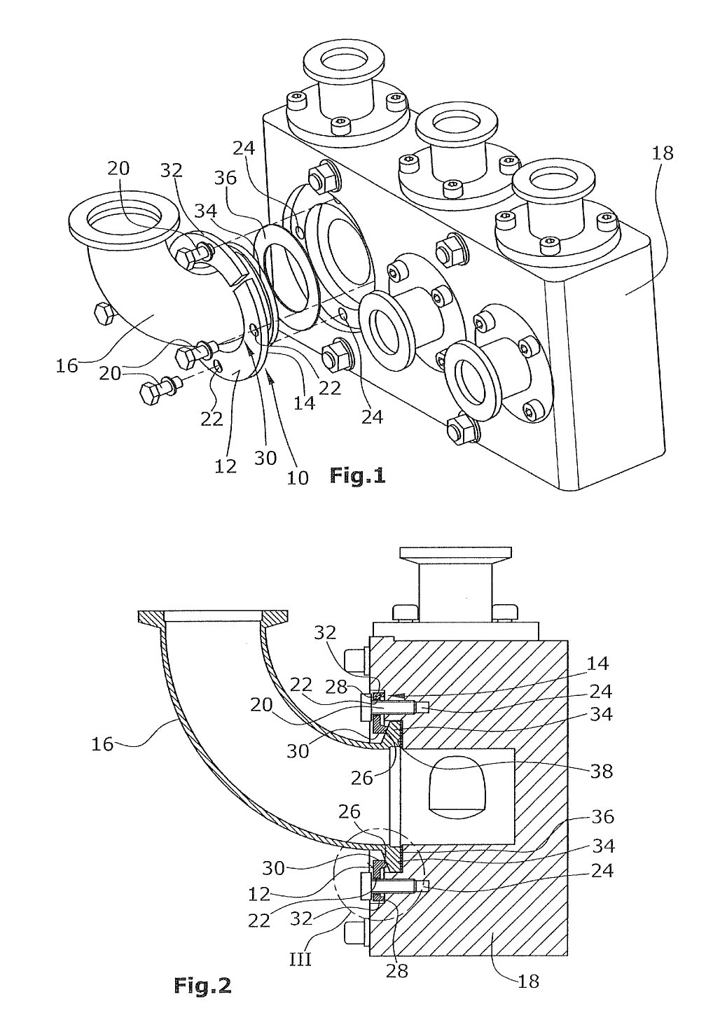

FIG. 2 is a sectional view of the flange connection shown in FIG. 1, and

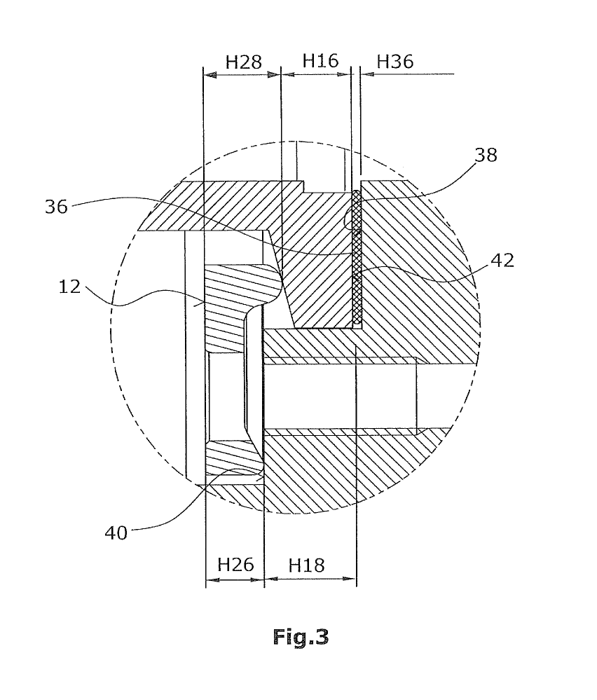

FIG. 3 is an enlarged view of the area marked by the chain-dotted circle III in FIG. 2.

The flange 10 is formed as a two-part ring and comprises a top side 12 and a bottom side 14. For connecting a pipe conduit 16 to a connection block 18, said bottom side 14 is assigned to the connection block 18 and to the pipe conduit 16, whereas said top side 12 is assigned to fastening means 20 in the form of screws. In this context, the term “assigned” is to be understood in the sense that, in the attached state of flange 10, the bottom side 14—as shown in FIG. 2—contacts the connection block 18 and the pipe conduit 16 whereas the heads of the screws 20 are in abutment on the opposite top side 12. In this arrangement, the screws 20 are inserted into openings 22 extending all the way through the flange 10 from its top side 12 to its bottom side 14. The screws are screwed into screw holes 24 of connection block 18 and press the flange 10 both against the connection block 18 and against the pipe conduit 16.

On the bottom side 14 of flange 10, there are respectively formed an inner contact web 26 and an outer contact web 28. The inner contact web 26 is arranged adjacent to the inner edge 30 of flange 10, and the outer contact web 28 is adjacent to the outer edge 32 of flange 10. In the assembled state—as shown in the Figures—of the two-part flange 10, the two sections of each contact web 26, 28 of the two parts of flange 10 form a continuous circular ring along the bottom side 14. In this arrangement, the height H26, H28 of each of the two contact webs 26, 28 is constant along the entire circular periphery. The height H26, H28 of the respective contact web 26, 28 is the length dimension of the contact web from the bottom side 14 up to its end opposite to the bottom side 14. The width of each contact web, i.e. its radial dimension from the outside to the inside, decreases with increasing distance from the bottom side 14. The end of the outer contact web 28 opposite to the bottom side 14 is functional as a contact face for the connection block 18. The end of the inner contact web 26 opposite to the bottom side 14 is functional as a contact face for the pipe conduit 16.

On that end of the pipe conduit 16 that is to be connected to connection block 18, the pipe conduit is provided with a continuous circular collar 34 projecting toward the outside. In the fastened state illustrated in FIG. 2, the projecting end of the inner contact web 26 is in contact with the collar 34 of pipe conduit 16, and the projecting end of the outer contact web 28 is in contact with an abutment face 40 of connection block 18 in a recess for flange 10. Between the collar 34 of pipe conduit 16 and an abutment face 38 of connection block 18, a ring seal 36 is provided. In FIGS. 2 and 3, ring seal 36 is shown in the pressed state. In this arrangement, ring seal 36 is functional to seal the gap between collar 34 and connection block 18. In the pressed state, ring seal 36 has a height H36.

In the above arrangement, ring seal 36 is arranged between a contact face 42 of collar 34 facing toward connection block 18 and the abutment face 38 of connection block 18 facing toward contact face 42. In the state of pipe conduit 16 as connected to connection block 18, ring seal 36 is compressed between the two surfaces 38 and 42.

Between the contact point of inner contact web 26 with collar 34 and the opposite contact face of the latter, collar 34 has a height H16. Connection block 18 has a height H18 between its abutment face 40 for the outer contact web 28 and its abutment face 38. In the state of pipe conduit 16 as connected to connection block 18, in which state the ring seal 36 has been compressed, said heights H16, H18, H26, H28 and H36 fulfill the following relationship:

H18+H26=H16+H28+H36.

In other words, this means that, in the connected state of pipe conduit 16, the flange 10 is oriented vertically to the longitudinal axis of the screws 20 and the ring seal 36 exerts a force in the longitudinal direction of the screws whereby the screws 20 are mainly subjected to tension. In this state, the screws largely receive tensional forces and only negligible bending moments so that the flange connection is particular stable and safe.

1. A flange for establishing a releasable connection of a pipe conduit to a connection block, said flange being provided as an interrupted ring having an inner and an outer edge, and said flange further comprising a bottom side formed for abutment on the connection block and on the pipe conduit, and a top side arranged opposite to the bottom side and formed for abutment of fastening means for fastening the flange to the connection block, wherein
the flange comprises an outer contact web for the connection block, said outer contact web extending from the bottom side in the area of the outer edge, and further comprises an inner contact web for the pipe conduit, said inner contact web extending from the bottom side in the area of the inner edge.

2. The flange according to claim 1, wherein the two contact webs are respectively arranged orthogonally to the bottom side.

3. The flange according to claim 1, wherein each contact web has a constant height along its periphery, the heights of the inner and of the outer contact web being different from each other.

4. The flange according to claim 1, wherein each contact web has a decreasing width toward its end opposite to the bottom side.

5. The flange according to claim 1, wherein the inner edge and the outer edge delimit the flange toward the inside and respectively the outside.

6. The flange according to claim 1, wherein the inner edge and the outer edge are respectively arranged orthogonally to the bottom side and the top side.

7. The flange according to claim 1, wherein the flange is provided with a plurality of openings extending through the flange from the bottom side to the top side and designed to receive fastening means in the form of screws.

8. The flange according to claim 1, wherein the interrupted ring element consists of a two equally sized parts.

9. The flange according to claim 1, wherein
the height H26 of the inner contact web,
the height H28 of the outer contact web,
the height H18 between the abutment face of the connection block for the outer contact web and the abutment face of the connection block for the pipe conduit and
the height H16 of the pipe conduit between its contact face facing toward the connection block and its contact point to the inner contact web fulfill the relation
H18+H26=H16+H28+H36,
wherein H36 is the height of a ring seal between the abutment face and the contact face in the pressed state.
